(19) United States
(12) Patent Application Publication
(10) Pub. No.: US 2016/0326471 A1
(43) Pub. Date: Nov. 10, 2016

(54) APPLIANCE FOR BREWING BEER

(71) Applicant: WHIRLPOOL CORPORATION, Benton Harbor, MI (US)

(72) Inventors: Bryan David Aown, Granger, IN (US); Suzanne M. Berberet, St. Joseph, MI (US); Anthony Gates, St. Joseph, MI (US); Charles Anthony Mills, Wyoming, MI (US); Robert J. Schneider, Fennville, MI (US)

(73) Assignee: WHIRLPOOL CORPORATION, Benton Harbor, MI (US)

(21) Appl. No.: 14/705,543

(22) Filed: May 6, 2015

(51) Int. Cl. C12C 11/00

(52) U.S. Cl. CPC C12C 11/00

(57) ABSTRACT

An appliance includes an appliance for the home-brewing of beer that includes a brewing unit including a heating unit, a recirculation pump, a first steeping chamber having an inlet and a flow-controlled outlet, a supply line in fluid communication with the inlet, and a collector in fluid communication with the outlet. The recirculation pump has a draw line in fluid communication with the collector. The appliance further includes a fermenting unit physically separate from the brewing unit and having a vessel adjacent a temperature control assembly. The fermenting unit is selectively fluidically coupleable with the brewing unit for transfer of fluid from the brewing unit to the fermenting unit and fluidically decouplable from the brewing unit.

### BACKGROUND

The present device generally relates to an appliance for brewing beer. In particular, the appliance includes a modular assembly of a brewing unit and a fermenting unit.

The beer-brewing process generally includes two phases: a wort brewing phase and a fermenting phase. The brewing phase involves steeping malted grain (typically barley) and, optionally, various cereal adjuncts and other additives with heated water, before bringing the resulting liquid to a boil or near-boil (e.g. about 207° F.) and, subsequently, adding hops and other additives in a timed application. The brewing process may take between two and three hours. The fermenting phase involves quickly cooling the hopped wort and adding yeast thereto before retaining the fermenting liquid at a desired temperature (which may vary depending on whether the beer is an ale or lager). Further additives may be steeped with the fermenting liquid, which may include “dry hopping” or the like. The fermenting process may take between one and three weeks depending on the desired characteristics of the finished beer.

Automated units exist for controlling the temperatures and durations of both the brewing and fermenting stages, along with the intermediate stages thereof. However, such units require that any components used only for the brewing stage remain unused during the much longer fermenting stage. Accordingly, further advances may be desired.

### SUMMARY

In at least one aspect, an appliance for brewing beer includes a brewing unit including a heating unit, a recirculation pump, a first steeping chamber having an inlet and a flow-controlled outlet, a supply line in fluid communication with the inlet, and a collector in fluid communication with the outlet. The recirculation pump has a draw line in fluid communication with the collector. The appliance further includes a fermenting unit physically separate from the brewing unit and having a vessel adjacent a temperature control assembly. The fermenting unit is selectively fluidically coupleable with the brewing unit for transfer of fluid from the brewing unit to the fermenting unit and fluidically decouplable from the brewing unit.

In at least another aspect, a beer-brewing system includes a brewing unit including a steeping assembly having a draw line in fluid communication therewith the collector and a supply line in fluid communication with the inlet and a brewer mounting unit coupled with the brewing unit and supporting the brewing unit at a first height. The system further includes a first fermenting unit including a vessel. The first fermenting unit is selectively fluidically coupleable with the brewing unit for transfer of fluid from the brewing unit to the fermenting unit is also fluidically decouplable from the brewing unit. A first fermenter mounting unit is coupled with the first fermenting unit and supports the first fermenting unit at a second height below the first height. The first fermenter mounting is being engageable with the brewer mounting unit to retain the brewing unit above and in an engaged position with the first fermenting unit.

In at least another aspect, a method for brewing beer includes fluidically coupling a brewing unit of a modular brewing appliance with a first fermenting unit thereof. The method further includes initiating a first automated brewing process of the brewing appliance that includes the brewing unit recirculating fluid from a vessel of the first fermenting unit through a heater and at least one of a plurality of steeping vessels of the brewing unit to make a first wort and the first fermenting unit cooling the first wort and initiating a first fermenting process. The method further includes fluidically decoupling the brewing unit from the first fermenting unit.

These and other features, advantages, and objects of the present device will be further understood and appreciated by those skilled in the art upon studying the following specification, claims, and appended drawings.

### BRIEF DESCRIPTION OF THE DRAWINGS

In the drawings:

FIG. 1 is a front perspective view of a beer-brewing appliance;

FIG. 2 is a front view of the appliance of FIG. 1;

FIG. 3 is a schematic view of various components included in the appliance of FIG. 1;

FIG. 4 is side assembly view showing the modular physical decoupling and separation of a brewing unit and a fermenting unit of the appliance of FIG. 1;

FIG. 5 is a front view of a brewing unit in assembled with a first fermenting unit arranged with a plurality of additional fermenting units that can be used with the brewing unit and in a stand-alone manner; and

FIG. 6 is a detail view of components of the appliance of FIG. 1.

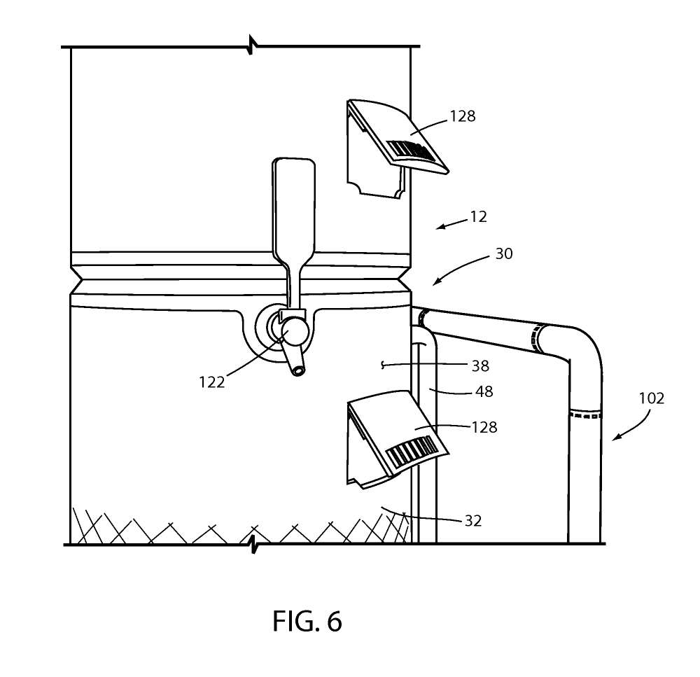

### DETAILED DESCRIPTION OF EMBODIMENTS

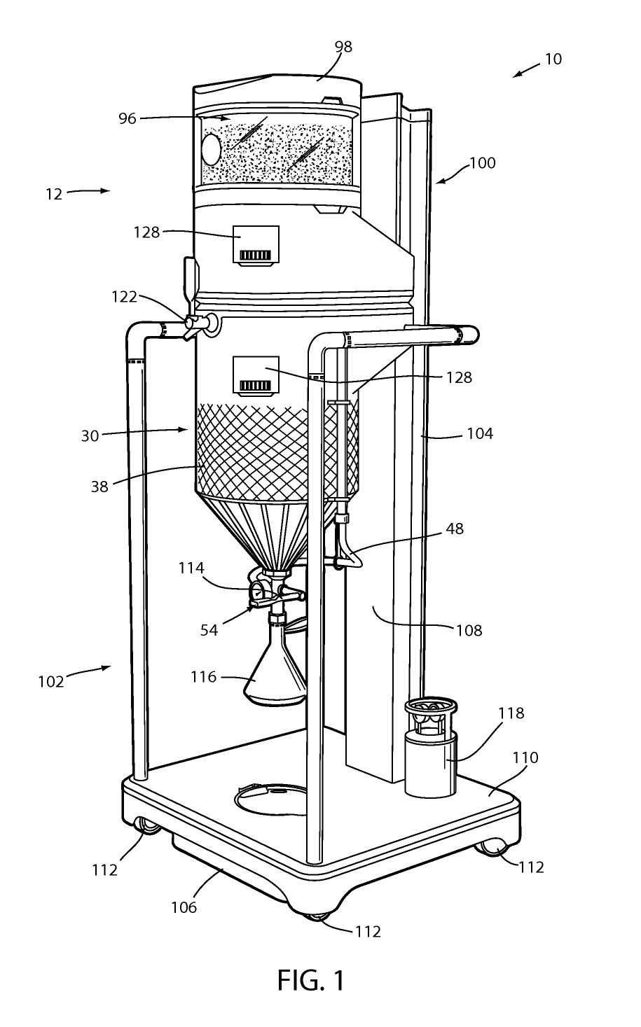

For purposes of description herein the terms “upper,” “lower,” “right,” “left,” “rear,” “front,” “vertical,” “horizontal,” and derivatives thereof shall relate to the device as oriented in FIG. 1. However, it is to be understood that the device may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Referring to the embodiment illustrated in FIGS. 1-3, reference numeral 10 generally designates an appliance for brewing beer. Appliance 10 includes a brewing unit 12 including a heating unit 14, which may be in the form of a heating block, for example, a recirculation pump 16, a first steeping chamber 18 having an inlet 20 and flow-controlled outlet 22. Brewing unit 12 also has a supply line 24 in fluid communication with the inlet 20, and a collector 26, which may be in the form of, for example, a collection pan or a manifold, in fluid communication with the outlet 22. The recirculation pump 16 has a draw line 28 in fluid communication with the collector 26. Appliance 10 further includes a fermenting unit 30 physically separate from the brewing unit 12 and including a vessel 32 adjacent a temperature control assembly 34. The brewing unit 12 is selectively fluidically coupleable with the fermenting unit 30 for transfer of fluid from the brewing unit 12 to the fermenting unit 30. Fermenting unit 30 is further fluidically de-coupleable from the brewing unit 12.

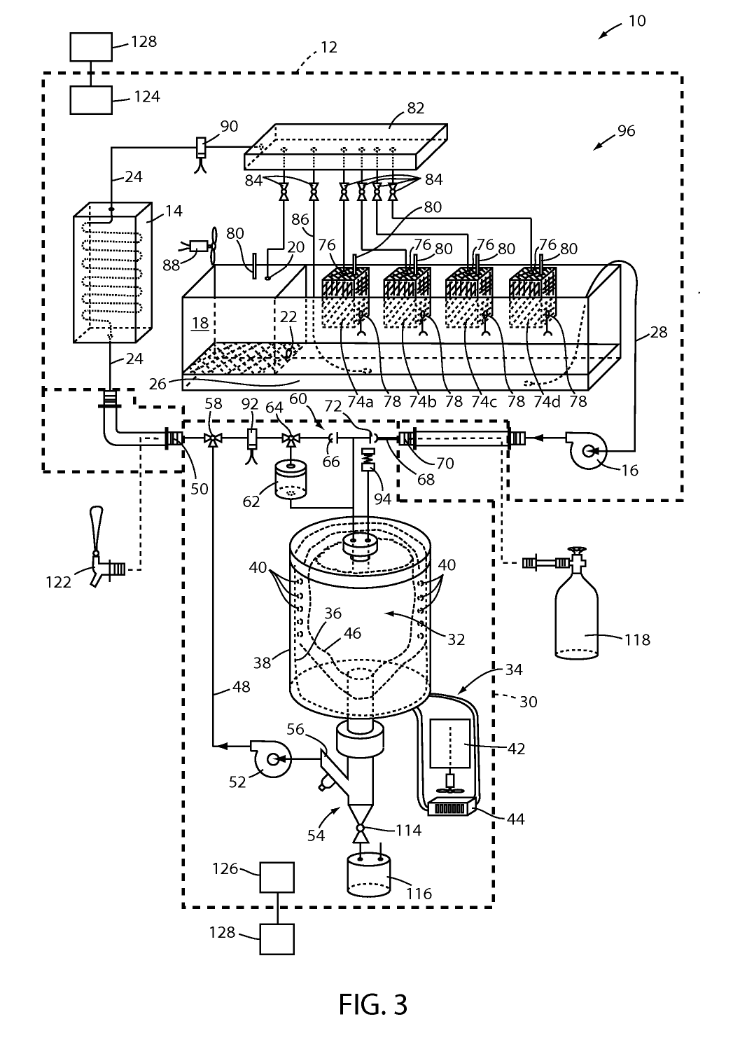

As shown in FIG. 3, which schematically depicts appliance 10, including various internal components of both brewing unit 12 and fermenting unit 30, fermenting unit 30 includes a temperature control assembly 34, as discussed above, positioned between a vessel wall 36 and an outer wall 38 of fermenting unit 30. In particular, temperature control assembly 34 includes coolant coils 40 which are positioned between vessel wall 36 and outer wall 38, preferably at least adjacent vessel wall 36. A compressor 42 is coupled with coolant coils 40 for driving the movement of a coolant therethrough so as remove heat from vessel 32 through vessel wall 36 and through a heat exchanger 44 remote from vessel wall 36. In this manner, fermenting unit 30 may be operable to retain a fluid within vessel 32 at a temperature below ambient temperature in the vicinity of appliance 10.

As further shown, vessel 32 may contain a fluid bag 46 therein that may be shaped so as to substantially match an inner profile of vessel wall 36 such that fluid bag 46 can contain an amount of fluid generally matching the inner volume of vessel 32. Further, bag 46 may be generally flexible such that bag 46 can collapse when a volume of fluid contained therein is less than a volume of vessel 32 this may allow for generally even pressure control of an interior of bag 46, including any fluid therein, as well as a reduction of ambient air within bag 46 adjacent to any fluid therein. Further, bag 46 may be removable from vessel 32 such that a particular bag 46 may be disposed of after use and replaced with a further bag 46 to facilitate clean-up of fermenting unit 30 between uses.

As further shown in FIG. 3, fermenting unit 30 further includes a first line portion 48 including a coupling 50 on an end thereof opposite a fermenter pump 52, which may be adjacent an outlet assembly 54 of vessel 32. Coupling 50 may be removably coupleable with a portion of supply line 24 of brewing unit 12 so as to achieve at least a portion of the above-mentioned fluidic coupling of fermenting unit 30 with brewing unit 12. In this manner, first line portion 48 may, when coupled with supply line 24, effectively become a portion thereof, allowing a fluid supply within vessel 32 to be supplied to brewing unit 12. In particular, fermenter pump 52 may be coupled with outlet assembly 54 at a port 56 thereof to draw fluid from out of vessel 32 and through first line portion 48. As further illustrated, first line portion 48 may include a redirect valve 58 in fluid communication therewith for controlling fluid flow from fermenter pump 52 and into supply line 24. Redirect valve 58 may also be in fluid communication with an inlet line 60 to an upper portion of vessel 32 to selectively allow return of fluid provided by fermenter pump 52 back into vessel 32. Second line portion 58 may further be in communication with a yeast vessel 62 such that a yeast add valve 64 associated therewith may be selectively manipulated to cause at least a portion of such redirected fluid from fermenter pump 52 to pass from yeast vessel 62 prior to further movement through inlet line 60 and into vessel 32. A bypass check valve 72 may be included to force flow of redirected fluid directly into second line portion, without passing through yeast vessel 62, in a single line without backflow into second line portion 68. As an alternative to an arrangement including check valve 72 (as well as check valve 66, discussed below), two separate inlets to vessel 32 may be provided.

As also shown in FIG. 3, fermenting unit 30 further includes a second line portion 68 having a coupling 70 that is selectively fluidically coupleable with a portion of draw line 28 downstream of recirculation pump 16. In this manner, brewing unit 12 is further fluidically coupleable with fermenting unit 30 by coupling of second line portion 68 with draw line 28 such that second line portion 68 may effectively become a portion of draw line 28. Second line portion 68 may further be fluidically couple with inlet lines 60 through a back-flow prevention check valve 66 such that fluid drawn out of collector 26 through draw line 28 by recirculation pump 16 can flow into vessel 32 for recirculation into brewing unit 12 by fermenter pump 52 drawing fluid from out of vessel 32 and into first line portion 48, as described above.

Continuing with respect to FIG. 3, brewing unit 12 is shown as including a plurality of additional steeping chambers in the form of additive chambers 74a, 74b, 74c, and 74d, each of which includes a respective inlet 76 and a respective flow-controlled outlet 78. As with the previously mentioned flow-controlled outlets 22, discussed above in connection with first steeping chamber 18, flow-controlled outlets 78 can be configured to allow the free flow of a portion of a fluid contained in a respective one of first steeping chamber 18 and additive chambers 74a, 74b, 74c, and 74d, at a rate configured to maintain at least some fluid therein for a predetermined amount of time. In particular, first steeping chamber 18 can be configured to retain a grain such as malted barley or the like or a mixture of a grain or various grains with additional ingredients in the form of a “grist” and to further retain a portion of fluid heated by heating unit 14 therein so as to interact with the grist within chamber 18. The configuration of flow-controlled outlet 22 may be such that the steeped fluid is slowly released from chamber 18 to allow the fluid therein to, at least partially, remain within chamber 18 for long enough to interact with the grist.

Similarly, additive chambers 74 can be configured to retain hops or other comparable ingredients therein for additional steeping with fluid heated by heating unit 14 and provided by supply line 24 for a predetermined amount of time, as provided by the flow such fluid through outlets 78. As discussed above, the fluid flowing out from chamber 18, as well as additive chambers 74a, 74b, 74c, 74d collects in collector 26 and is drawn out of collector 26 through draw line 28 by a recirculation pump 16. As further shown in FIG. 3, each of first steeping chamber 18 and additive chambers 74a, 74b, 74c, and 74d may include a respective air vent 80 or one or more air permeable walls, membranes, or mesh sections, to allow the escape of air therefrom as the associated chambers 18 and/or 74a, 74b, 74c, or 74d are filled with fluid.

As further shown in FIG. 3, brewing unit 12 may include a manifold unit 82 with a plurality of supply valves 84, each being respectively associated with one of first steeping chamber 18 and the additional steeping chambers in the form of additive chambers 74a, 74b, 74c, and 74d. The supply valves 84 may selectively allow for the flow of fluid from supply line 24 to particular ones of first steeping chamber 18 and additive chambers 74a, 74b, 74c and 74d. This can allow for exposure of such fluid particular ones of such chambers for infusion of such fluid with the ingredients therein for particular durations and at particular times within a brewing cycle, as discussed further below. A further supply valve 84 may be coupled with a bypass line 86 that may allow for a flow of fluid from supply line 24 directly into collector 26 for recirculation through vessel 32 and, in a particular example through heating unit 14, without flowing through either first steeping chamber 18 or additive chamber 74a, 74b, 74c, or 74d. As further shown in FIG. 3, brewing unit 12 may further include a foam fan 88 in connection with first steeping chamber 18 to allow a for a forced flow of air along an upper portion thereof for reduction in any foam that may accumulate therein during steeping of the fluid with grist contained therein.

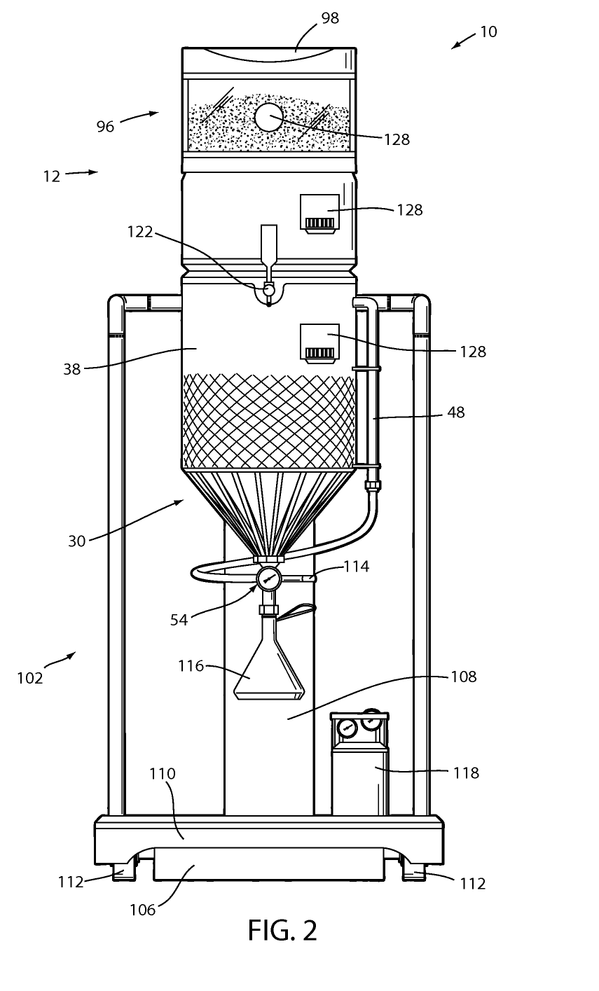

The above-described components of FIG. 3, as incorporated into the appliance 10 shown generally in FIGS. 1 and 2, may allow for an automated brewing process to be implemented by appliance 10 when brewing unit 12 is assembled with fermenting unit 30, including fluid coupling of fermenting unit 30 with both supply line 24, via first line portion 48, as well as draw line 28, via second line portion 68. In particular, such a process may include drawing out an initial supply of water from vessel 32 by fermenter pump 52, which may then be forced through first line portion 48, including through heating unit 14, which may serve to heat the water flowing therethrough. Before the water passes through manifold unit 82, a brewing thermistor 90 measures the temperature of such water to determine if it is within a temperature range desired for “mashing,” which includes the steeping of water within the grist contained within first steeping chamber 18. If the water is not of a sufficient temperature (for example, between about 105° F. and 155° F.) the water is directed through the supply valve 84 associated with bypass line 86 to collect within collector 26 for recirculation through draw line 28 by recirculation pump 16, which returns the partially-heated water to vessel 32.

The above heating cycle repeats until the recirculating water reaches a desired temperature for mashing, at which point the supply valve 84 associated with first steeping chamber 18 is opened, allowing the flow of water thereinto. The supply of water into first steeping chamber 18 continues, with a portion thereof returning to collector 26 for further recirculation, as described above, which may include recirculation back into first steeping chamber 18 until the desired time for mashing, which in an example may be about an hour, has taken place. Subsequently, the temperature of the wort may be raised to about 170° F. for sparging or final rinsing.

Subsequent to mashing, the resulting “wort” is further recirculated, such as through bypass line 86, if necessary, until the wort reaches a boiling or near-boiling (e.g., about 200° F. to about 207° F.) temperature thereof. At this point, the heated wort is selectively provided via supply valves 84, to desired ones of the additive chambers 74a, 74b, 74c, and 74d. As discussed above, additive chamber 74a, 74b, 74c, and 74d may contain hops or other various ingredients, including different varieties of hops, for example. Such ingredients may be infused with the wort at different times or for different durations, as desired according to the particular recipe being used. It is noted that all additive chambers 74a, 74b, 74c, and 74d do not have to be used in such a cycle, and that with particular recipes only one such chamber 74a may be used for example.

After a desired period of time, the hoped wort is then moved completely into vessel 32, by recirculation pump 16. This may be done with fermenter pump 52 continuing to move the fluid through first line portion 48, but with redirect valve 58 positioned so as to circulate the fluid through inlet 60 and back into vessel 32. At this point temperature control assembly 34 is used to rapidly cool the wort within vessel 32 to a temperature at which yeast can safely be added thereto. Further, a fermenter thermistor 92 may be included along a portion of second line portion 58 to monitor the temperature of the fluid circulating therethrough. In a further example, fermenter pump 52 may be used continuously or periodically during fermentation to circulate the fermenting wort. In an alternative arrangement, the wort may be cooled while stagnant in vessel 32 (i.e. with fermenter pump 52 in an off state). In such an arrangement thermistor 92 may be repositioned to be within vessel 32 or an additional thermistor may be included in such a location.

Once the wort has been appropriately cooled, yeast add valve 64 may be opened, allowing all or a portion of the wort to pass through yeast vessel 62, thereby adding the yeast contained therein to the wort and, thusly, beginning the fermentation process. Once the yeast from yeast vessel 62 has been flushed into the wort and a desired amount of circulation for temperature homogenization and yeast dispersion has been achieved, fermenter pump 52 may be deactivated, allowing the fermenting wort to be retained completely within vessel 32, such as within bag 46 contained therein, for fermentation at a controlled temperature via appropriate use of temperature control assembly 34. Additional ingredients can be added at this stage as well, including the addition of more hops (i.e. for “dry hopping”). As further shown in FIG. 3, a pressure release valve 94 may allow for the release of carbon-dioxide produced during fermentation at a preset release pressure (for example, 12 pounds per square-inch (“p.s.i.”), while maintaining adequate pressure within vessel 32 to avoid or reduce any need for subsequent re-carbonation.

Fermenting may be allowed to continue until the resulting the beer has developed the desired flavor characteristics and specific gravity (i.e. alcohol content, by volume). This fermenting stage can take for example, between one and three weeks, which is significantly longer than the above-described brewing process, which may take between one and three hours. Accordingly, while fermenting unit 30 is involved in the brewing process, brewing unit 12 is not involved in the fermenting process and, accordingly may go otherwise unused if coupled with fermenting unit 30 during the fermentation process. Accordingly, as described above, fermenting unit 30 may be fluidically decoupled from brewing unit 12, such as by decoupling of both first and second line portions 48 and 68 from the respective supply line 24 and draw line 28. As further described above, fermenting unit 30 and brewing unit 12 may be physically separate units such that brewing unit may be physically separated from fermenting unit 30 during the fermentation process. As further shown in FIG. 1, first steeping chamber 18 may be included in a visible steeping assembly 96, that may also include additive chambers 74a, 74b, 74c, and 74d, the steeping assembly 96 including a lid 98 thereon to make such chambers available for a user to add the particular ingredients desired.

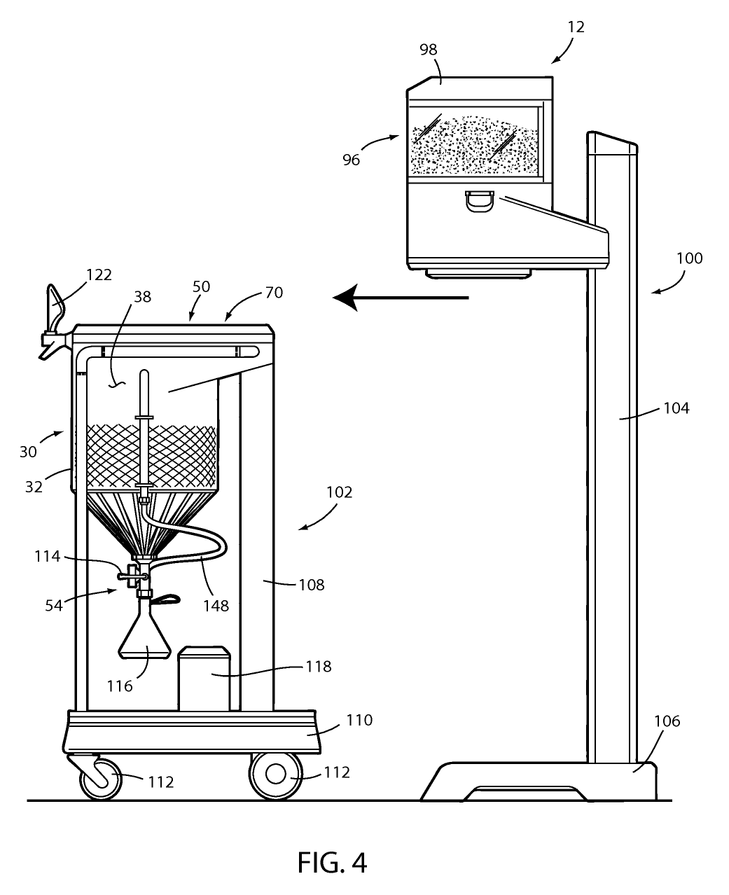

As shown in FIG. 4, brewing unit 12 and fermenting unit 30 may be physically attachable and detachable together, such as for physical assembly together during the above-described brewing process and physical separation thereof during the above-described fermentation process. In an example, first line portion 48 and second line portion 68, as well as the respective couplings 50 and 70 thereof may be specifically structured so as to fluidically couple and decouple with supply line 24 and draw line 28, respectively during such physical attachment and detachment of brewing unit 12 with fermenting unit 30. Such attachment and detachment may also include electrically coupling and decoupling brewing unit 12 with fermenting unit 30, including for various forms of communication between brewing unit 12 and fermenting unit 30 (e.g., for coordination of functions described herein). In one example, a USB connection may be arranged between respective controllers or on-board computers in brewing unit 12 and fermenting unit 30 that electrically couples and decouples with the physical attachment and detachment therebetween.

As further shown in FIG. 4, brewing unit 12 and fermenting unit 30 may be separately mounted to facilitate ease of such attachment and detachment together, as well as easy transportation of fermenting unit 30. In particular, brewing unit 12 may be mounted on a brewer mounting unit 100, and fermenting unit 30 may be separately mounted on a fermenter mounting unit 102. In particular, brewer mounting unit 100 may have a brewer stand 104 stably mounted on a brewer base 106 configured for stability resting on a surface, such as a floor or the like. Similarly, fermenter mounting unit 102 may have a fermenter stand 108 and a fermenter base 110 that may also be configured for stably resting on a surface. As shown in FIG. 4, fermenter base 110 may include a plurality of wheels 112 to allow for easy movement of fermenting unit 30, such as away from brewing unit 12.

As illustrated, fermenter mounting unit 102 may be structured so as to engage with brewing mounting unit for positioning of fermenting unit 30 in a location relative to brewing unit 12 for easy attachment of brewing unit 12 with fermenting unit 30. Such engagement may include positioning of fermenter base 110 above brewer base 106 and contact of fermenter stand 108 with at least a portion of brewer stand 104. In an example, such engagement may include fitting of a portion of fermenter stand 108 within a portion of brewer stand 104, or vice versa. Such an arrangement may facilitate attachment of brewing unit 12 with fermenting unit 30 by vertical movement of brewing unit 12 along brewer stand 104, which may include a track along with a counterweight, pneumatic elements, or the like to sufficiently maintain a desired vertical position of brewing unit 12 along brewer stand 104.

In this manner, brewing unit 12 and fermenting unit 30 may be assembled together by positioning of fermenting mounting unit 102 in an engaged relationship with brewer mounting unit 100 and, subsequent downward movement of brewing unit 12 along brewer stand 104 for engagement of brewing unit with fermenting unit 30, thereby achieving physical attachment therebetween and appropriate fluidic coupling of fermenting unit 30 with brewing unit 12. When thusly assembled, appliance 10 can be used for the brewing of a hopped wort, as described above. Further, when the brewing process is complete, brewing unit 12 can be moved upwardly along brewer stand 104, thereby detaching and fluidically decoupling brewing unit 12 from fermenting unit 30, at which point fermenter mounting unit 102 can be disengaged from brewer mounting unit 100, thereby allowing fermenting unit 30 to be moved away from brewing unit 12 during and subsequent to the above-described fermentation process.

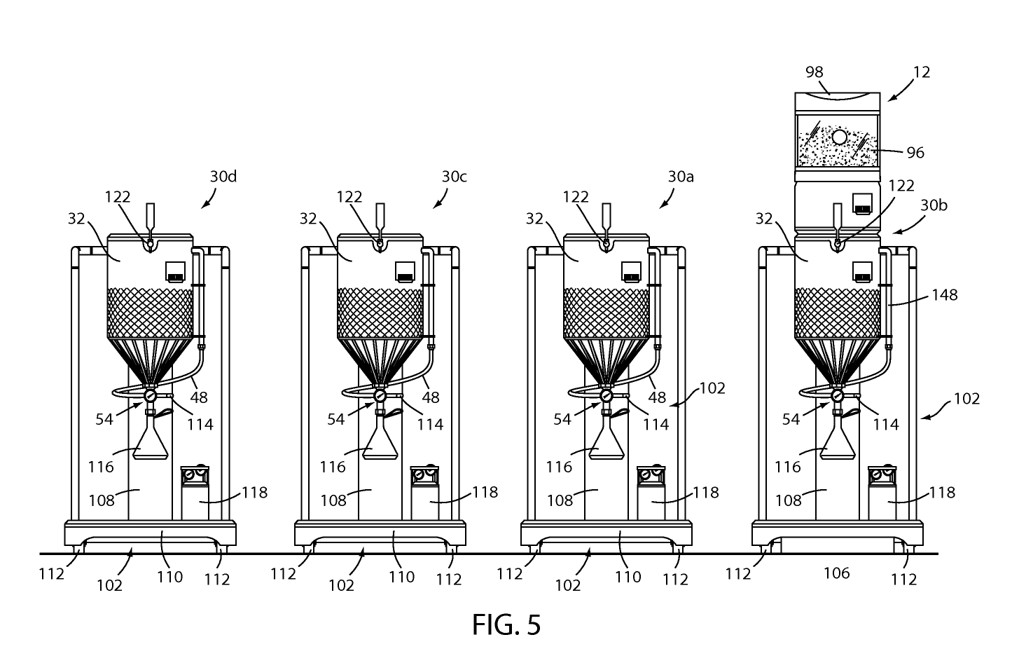

As shown in FIG. 5, the above-described modular assembly of fermenting unit 30 with brewing unit 12 may allow for the use of several such fermenting units 30a, 30b, 30c, and 30d, for example, to be used in a single modular appliance 10, as depicted. Such a modular appliance 10 may allow for user to complete a brewing cycle with, for example, a first such brewing unit 12a, before detachment and fluid decoupling of fermenting unit 30 with brewing unit 12 for use of fermenting unit 30a in a stand-alone manner for completion of the fermentation process. Simultaneously with such fermentation process, a second similarly-configured fermenting unit 30b may be assembled and fluidically coupled with brewing unit 12 to complete a second brewing process and transfer of the resulting wort, which may be of the same or a different recipe as that carried out with respect to fermenting unit 30a, before subsequent disassembly and decoupling of fermenting unit 30b from brewing unit 12. This process can be repeated with additional, subsequent fermenting units 30c and 30d, or further still fermenting units similar thereto to allow for simultaneous fermentation of several different batches of beer.

After completion of the above-described single or multiple fermentation processes using one or more fermenting units 30, the lower valve 114 on the outlet assembly 54 can be placed into an open condition, thereby allowing the sediment that collects to the bottom of vessel 32 to flow into trub jar 116 for removal from the finished beer. At this point, the finished beer may be transferred from out of vessel 32 and into a separate keg or container (such as a growler or one or more bottles, for example), such as through the coupling 50 of first line portion 48. Alternatively, fermenting unit 30 may be used as a dispensing unit such as by the connection of a carbon dioxide tank 118 (FIG. 3) with vessel 32, such as by fluidic coupling thereof coupling 70 of second line portion 68. To facilitate such dispensing, a tap 122 may be coupled with vessel 32, such as by coupling thereof with coupling 50 of first line portion 48.

The appliance 10 shown in the Figures for the modular assembly of brewing unit 12 and fermenting unit 30 is merely an example of an arrangement for the arrangement depicted in FIG. 3. In other examples, a brewing unit 12 may be physically attachable and detachable with a fermenting unit 30, including fluidic coupling and decoupling therebetween, in a horizontal arrangement. In another example, appliance 10 may include a cabinet or other enclosure that includes the components for fermenting unit, as depicted in FIG. 3, with a compartment or other receptacle for removeably receiving a modular brewing unit 12 that can be used in connection with several such cabinet-style fermenting units 30 in a modular manner similar to that which is described above.

In an embodiment of appliance 10, the above-described brewing and fermentation processes may be implemented and controlled by respective controllers 124 and 126 (FIG. 3) that may be electrically coupled with heating unit 14, recirculation pump 16, temperature control assembly 34, redirect valve 58, yeast add valve 64, supply valves 84, brewing thermistor 90, and fermenting thermistor 92 to allow for appropriate cycling and heating or cooling of fluid through fermenting unit 30 and brewing unit 12 and steeping of such heated fluid at appropriate times and for appropriate durations in first steeping chamber 18 as well as additive chambers 74a, 74b, 74c, and 74d to prepare the above-described hopped wort, as well as appropriate cooling thereof, yeast addition, and fermentation within fermenting unit 30. Such controllers 124 and 126 may be configured to communicate with each other and may, further be respectively coupled with displays 128 mounted on the exterior of both brewing unit 12 and fermenting unit 30 to allow for user control and feedback regarding the brewing process. Such controllers 124 and 126 may further be pre-programmed with various recipes, including the ingredients to be used therein, for provision thereof to a user, as well as appropriate temperature and cycle time information. Further, controllers 124 and 126 may be configured for connection with a wireless internet network for look up and downloading of various additional recipes and/or for communication with a user through a computer or other wireless device. In an example, controllers 124 and 126 may be wirelessly connectable with a personal computer, smartphone, tablet, or the like to allow a user to download and manipulate various recipes that can then be transmitted to appliance 10 for implementation.

It will be understood by one having ordinary skill in the art that construction of the described device and other components is not limited to any specific material. Other exemplary embodiments of the device disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the device as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present device. The exemplary structures and processes disclosed herein are for illustrative purposes and are not to be construed as limiting.

It is also to be understood that variations and modifications can be made on the aforementioned structures and methods without departing from the concepts of the present device, and further it is to be understood that such concepts are intended to be covered by the following claims unless these claims by their language expressly state otherwise.

The above description is considered that of the illustrated embodiments only. Modifications of the device will occur to those skilled in the art and to those who make or use the device. Therefore, it is understood that the embodiments shown in the drawings and described above is merely for illustrative purposes and not intended to limit the scope of the device, which is defined by the following claims as interpreted according to the principles of patent law, including the Doctrine of Equivalents.

1. An appliance for brewing beer, comprising:
a brewing unit including a first housing defining an interior cavity and an exterior having a lower face, and, within the first housing, a heating unit, a recirculation pump, a first steeping chamber having an inlet and a flow-controlled outlet, a supply line in fluid communication with the inlet, and a collector in fluid communication with the outlet, the recirculation pump having a draw line in fluid communication with the collector; and
a fermenting unit including a second housing defining an interior cavity and an exterior having an upper face and, within the interior cavity, a vessel adjacent a temperature control assembly, the fermenting unit being selectively physically coupleable with the brewing unit between the lower face of the first housing and the upper face of the second housing and selectively fluidically coupleable with the brewing unit for transfer of fluid between the brewing unit and the fermenting unit and fluidically decouplable from the brewing unit.

2. The appliance of claim 1, wherein the fermenting unit is selectively fluidically coupleable with the brewing unit by a first line portion of the fermenting unit that is coupleable within the supply line of the brewing unit with the vessel in fluid communication with the first steeping chamber.

3. The appliance of claim 1, wherein the fermenting unit is selectively fluidically coupleable with the brewing unit by a second line portion of the fermenting unit that is coupleable within the draw line of the brewing unit with the vessel in fluid communication with the collector.

4. The appliance of claim 3, wherein the fermenting unit further includes, within the second housing, a yeast vessel in fluid communication with the second line portion.

5. The appliance of claim 1, wherein the brewing unit further includes, within the first housing, a second steeping chamber and further includes a manifold unit within the supply line between the heating unit and both the first and second steeping chambers, the manifold including first and second valves respectively associated with each of the first and second steeping chambers for allowing and preventing fluid flow from the supply line thereinto.

6. The appliance of claim 1, further including a mounting unit with a first portion coupled with the fermenting unit and a second portion coupled with the brewing unit and positionable adjacent the first portion to retain the brewing unit above and axially aligned with the fermenting unit;
wherein the selective physical coupling of the fermenting unit with the brewing unit is achievable with the brewing unit positioned above and axially aligned with the brewing unit.

7. The appliance of claim 6, wherein a selective physical coupling of the fermenting unit with the brewing unit further achieves the selective fluid coupling of the fermenting unit with the brewing unit.

8. A beer-brewing system, comprising:
a brewing unit including a steeping assembly having a draw line in fluid communication with a collector and a supply line in fluid communication with an inlet thereof;
a brewer mounting unit coupled with the brewing unit and supporting the brewing unit at a first height;
a first fermenting unit including a vessel, the first fermenting unit being selectively fluidically coupleable with the brewing unit for transfer of fluid from the brewing unit to the first fermenting unit and fluidically decouplable from the brewing unit; and
a first fermenter mounting unit coupled with the first fermenting unit and supporting the first fermenting unit at a second height below the first height, the first fermenter mounting unit being selectively engageable with the brewer mounting unit to retain the brewing unit directly above and in physically engaged position with the first fermenting unit and disengageable from the brewer mounting unit to physically separate the first fermenting unit from the brewing unit.

9. The system of claim 8, further including:
a second fermenting unit selectively fluidically coupleable with the brewing unit in place of the first fermenting unit; and
a second fermenter mounting unit coupled with the second fermenting unit and supporting the second fermenting unit at the second height, the second fermenter mounting unit being engageable with the brewer mounting unit in place of the first fermenter mounting unit to retain the brewing unit directly above and in an engaged position with the second fermenting unit and disengageable from the brewer mounting unit to physically separate the second fermenting unit from the brewing unit.

10. The system of claim 8, wherein the brewing unit further includes a heating unit, a recirculation pump, a first steeping chamber having an inlet and a flow-controlled outlet, and a collector in fluid communication with the outlet, the recirculation pump operatively coupled with the draw line.

11. The system of claim 8, wherein the first fermenting unit further includes a temperature control assembly adjacent the vessel.

12. The system of claim 8, wherein the first fermenting unit further includes a first line portion fluidically coupled with the vessel, the system further comprising a tap unit fluidically coupleable with the first line portion.

13. The system of claim 8, wherein the first fermenting unit further includes a second line portion, the first fermenting unit being fluidically coupleable with the brewing unit by the second line portion, the system further comprising a carbon-dioxide tank fluidically coupleable with the second line portion in place of the brewing unit.

14. The system of claim 8, wherein:
the brewing unit is removably coupleable with the first fermenting unit with the brewing unit positioned above the first fermenting unit; and
a removable coupling of the first fermenting unit with the brewing unit fluidically and electrically couples the fermenting unit with the brewing unit.

15-20. (canceled)

21. The appliance of claim 2, wherein the fermenting unit is further selectively fluidically coupleable with the brewing unit by a second line portion of the fermenting unit that is coupleable with the recirculation line of the brewing unit with the vessel in fluid communication with the collector.

22. The appliance of claim 21, further including:
a first controller within the first housing and in electrical communication with the recirculation pump;
a fermenter pump within the second housing and in fluidic communication with the first line portion; and
a second controller within the second housing and in electrical communication with the fermenter pump;
wherein the first controller and the second controller are electrically connectable with each other to control recirculation of a fluid between the brewing unit and the fermenting unit by respectively controlling the recirculation pump and the fermenter pump in a coordinated manner.

23. The appliance of claim 22, wherein physical coupling of the fermenting unit with the brewing unit fluidically couples the fermenting unit with the brewing unit and electrically couples the first controller with the second controller.

24. The system of claim 10, wherein:
the first fermenting unit is selectively fluidically coupleable with the brewing unit by a first line portion of the fermenting unit that is coupleable with the supply line of the brewing unit, with the vessel in fluid communication with the steeping assembly; and
the first fermenting unit is further selectively fluidically coupleable with the brewing unit by a second line portion of the first fermenting unit that is coupleable with the recirculation line of the brewing unit with the vessel in fluid communication with the collector.

25. The system of claim 24, further including:
a first controller within the brewing unit and in electrical communication with the recirculation pump;
a fermenter pump within the first fermenting unit and in fluidic communication with the first line portion; and
a second controller within the first fermenting unit and in electrical communication with the fermenter pump;
wherein the first controller and the second controller are electrically connectable with each other to control recirculation of a fluid between the brewing unit and the first fermenting unit by respectively controlling the recirculation pump and the fermenter pump in a coordinated manner.

26. The appliance of claim 25, wherein, when the first fermenting unit is in the physically engaged position with the brewing unit, the first controller is electrically coupled with the second controller.
